(19) United States
(12) Patent Application Publication
(10) Pub. No.: US 2008/0056817 A1
(43) Pub. Date: Mar. 6, 2008

(54) CORNER CONNECTOR FOR RECTANGULAR DUCT WORK

(76) Inventor: Salvatore Fasanella, Beaconsfield (CA)

Correspondence Address: WOOD, HERRON & EVANS, LLP, 2700 CAREW TOWER, 441 VINE STREET, CINCINNATI, OH, 45202, US

(21) Appl. No.: 11/468,391

(22) Filed: Aug. 30, 2006

(51) Int. Cl. E06B 3/984

(52) U.S. Cl. 403/401

(57) ABSTRACT

A corner for use in connecting flanges of duct sections includes two legs with a tab portion extending from each leg. The tab portion includes a portion that is co-planar with the surface of the corner allowing the corners to stack on each other without nesting. The corner is further configured so it can be utilized with both integral and non-integral flanges. Each leg of the corner has a stepped inner edge which at one portion is wide enough for use with an integral flange and at a distal end is narrow enough to be inserted into a non-integral flange.

### BACKGROUND OF THE INVENTION

Rectangular ducts transport air in buildings as part of the heating and air conditioning system. These ducts are generally made of sections of duct which are connected together. In order to connect the sections together, the duct is either formed with a peripheral flange at each end, or a peripheral flange is attached to the end of the duct section. Generally, separate corners are attached to these flanges to make a continuous rectangular flange around the periphery of each end of each section. The corners of the flanges of adjacent duct sections are bolted together to form a continuous duct.

An integral flange is formed by bending metal at each end of a duct section to form the flange with a peripheral lip. The corners snap fit into the flange trapped between this peripheral lip and the wall of the duct.

Non-integral flanges are L-shaped members that slide onto each end wall of a duct section. The flanges have an inner and outer wall which form a channel. Four corners are inserted into the channel of four adjacent flange sections to form a continuous rectangular flange. This is attached to the four walls of the duct. The corners of adjacent duct sections are bolted together, forming a continuous section of duct.

Due to the design of integral flanges, the corners can simply be snapped into position. An automatic applicator holding a stack of corners can be used to attach the corners to the flanges. In order for the applicator to function properly, the corners cannot nest or catch on each other as the bottom corner, i.e. the bottom corner in the stack must slide freely. Therefore, corners used with automatic applicators generally have a series of projections or tabs that keep the corners from nesting on each other. Also, the corners used with integral flanges generally have a peripheral flange that engages the lip of the integral flange. This holds the corner in position until the two duct sections are bolted together.

Typically, different corners are used to attach the non-integral flanges. The legs of the corner must slide into the channel. Therefore, the cross section of the legs of the corners must fit within the channel. Generally, the corners that are used for the automatic applicators have projections that prevent this.

### SUMMARY OF THE INVENTION

The present invention is premised on the realization that a properly configured corner can be used in either an integral or non-integral flange. Further, the corner can be applied with an automatic applicator.

The corner of the present invention has an exterior edge which includes a flange and an interior edge which is flat. The corners have two protrusions that extend from a body portion of each leg. The protrusions can support the corners so that they can be stacked. In one embodiment, the protrusions are tabs. The tabs each have a planar portion that supports one corners on top of another. The planar portion of the tabs separate adjacent stacked corners, preventing them from nesting. The protrusions extend across a balance line of the corner so that the corner is supported by only the two protrusions. The location of the protrusions is such that they do not prevent the corners from sliding into a channel of a non-integral flange. Further, the inner edge of the corner has a stepped cross section so that the distal ends of the legs are narrower than the proximal ends of the legs. This allows the legs to slide within the non-integral flanges. The larger cross section of the proximal portion of the corner creates a friction fit between the duct wall and the peripheral lip of the integral flanges.

The objects and advantages of the present invention will be further appreciated in light of the following detailed description and drawings.

### BRIEF DESCRIPTION OF THE DRAWINGS

FIG. 1 is a perspective view partially broken away of duct work incorporating the corner of the present invention;

FIG. 2 is a cross sectional view taken at lines 2-2 of FIG. 1;

FIG. 3 is a cross sectional view taken at lines 3-3 of FIG. 2;

FIG. 4 is a perspective view of a plurality of the corners of the present invention;

FIG. 5 is a cross sectional view partially broken away of an applicator used to install the corners of the present invention;

FIG. 6A is a diagrammatic view showing the installation of the corner in a non-integral flange;

FIG. 6B is a perspective view partially broken away and partially in phantom showing a corner of the present invention partially installed in a non-integral flange;

FIG. 7A is a diagrammatic view showing connection of non-integral flanges to corners of the present invention;

FIG. 7B is a cross sectional view partially in phantom showing the corner of the present invention attached to non-integral flanges.

FIG. 8 is a perspective view of the bottom side of a corner of the present invention.

FIG. 9 is a perspective view of an alternate embodiment of the present invention.

### DETAILED DESCRIPTION OF THE INVENTION

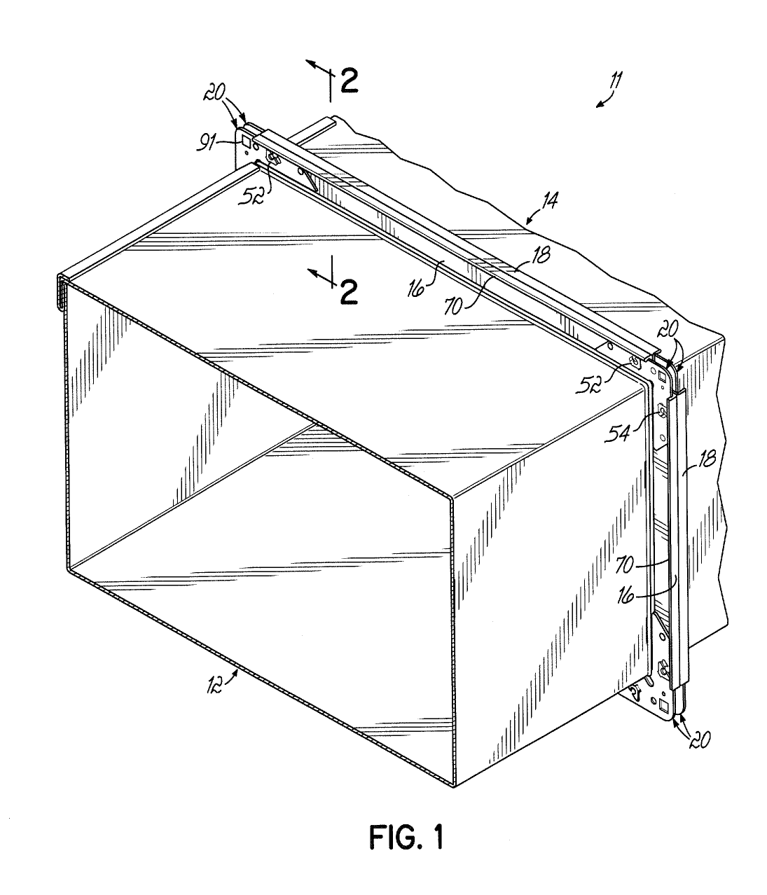

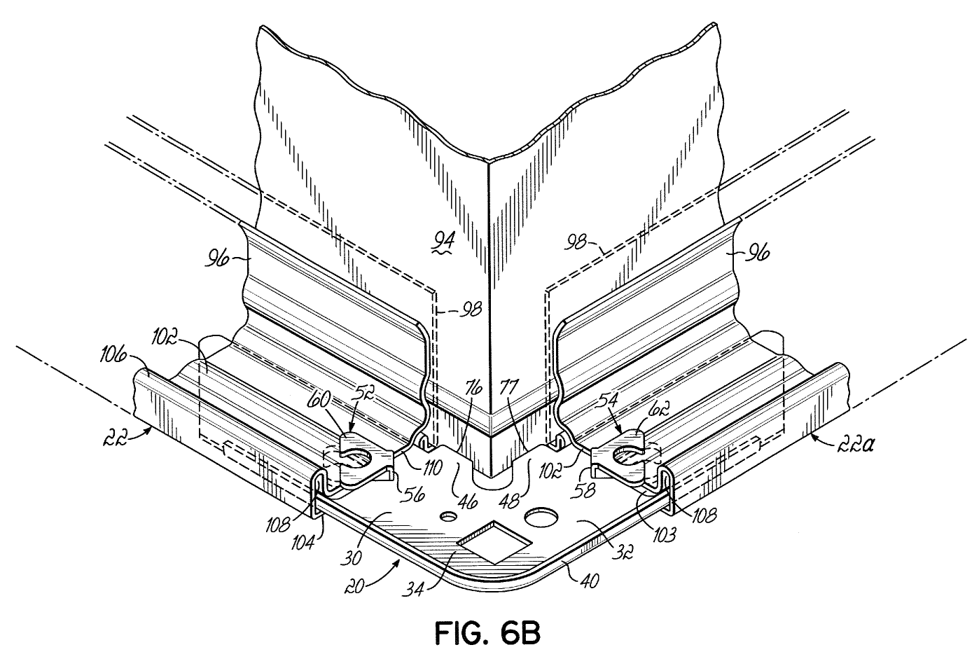

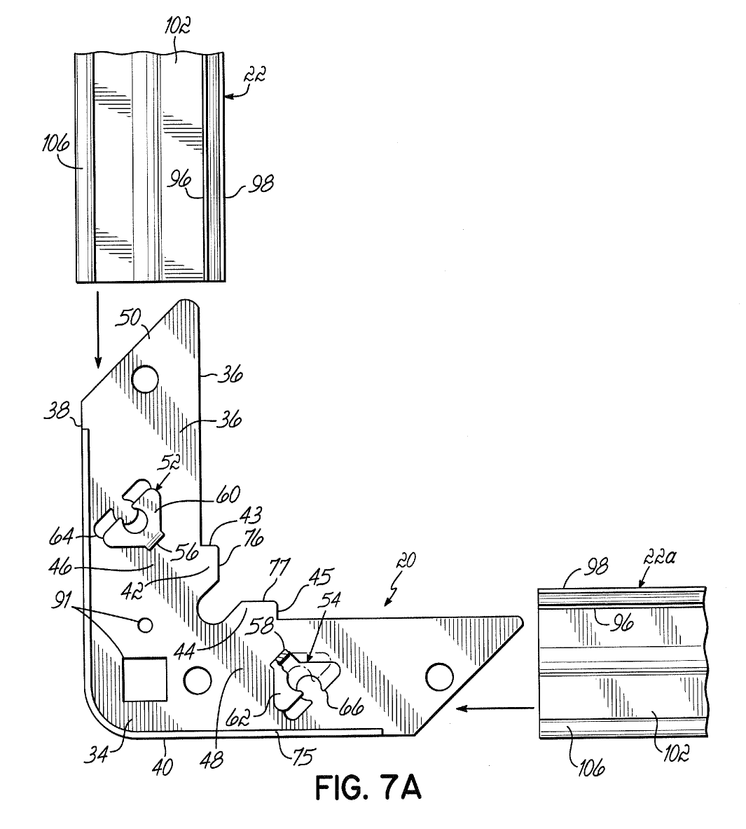

As shown in FIG. 1, there is a duct 11 which is formed from a first duct section 12 and a second duct section 14 which are held together along integral flanges 16 and 18, respectively. The flanges 16 and 18, and therefore the duct sections 12 and 14, are fastened together at corners 20, which are attached to the flanges 16 and 18. As shown in FIGS. 6A, 6B, 7A and 7B, the corners 20 can also be used with non-integral flanges 22 which are separately attached to the end 24 of duct sections.

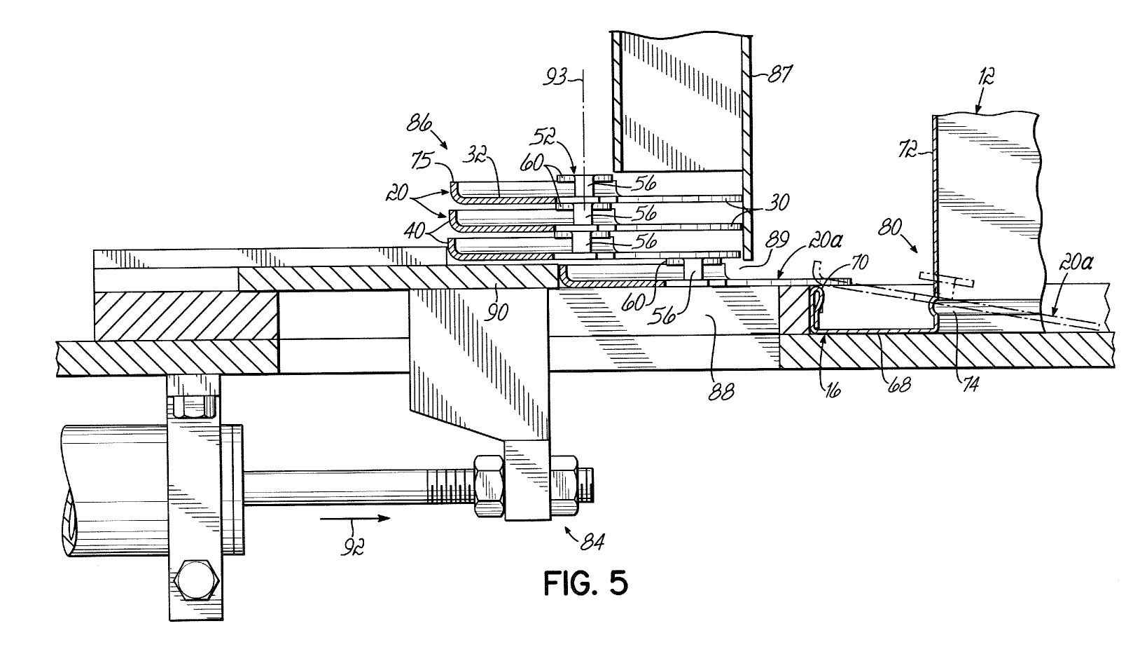

As shown more particularly in FIG. 4, the corners 20 include first leg 30 and a second leg 32 which join at a right angle relative to each other at a corner portion 34. The corner 20 includes an inner edge 36 and an outer edge 38. The outer edge 38 includes a flange 40 which extends in a first direction from the generally planar surface of corner 20.

Each leg 30 and 32 includes a stepped portion 42 and 44 near the proximal portions 46 and 48 of legs 30 and 32. This creates shoulders 43 and 45 on inner edge 36. Thus, the cross sections of the proximal areas 46 and 48 are wider than the cross sections of the distal portions 50 and 51 of legs 30 and 32, respectively.

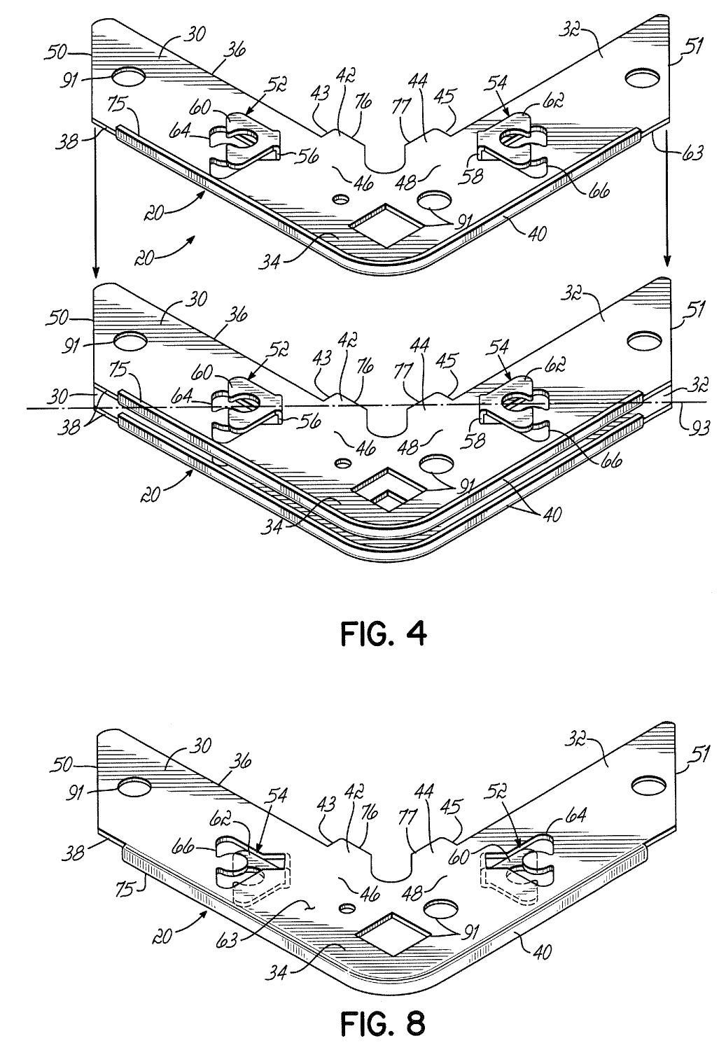

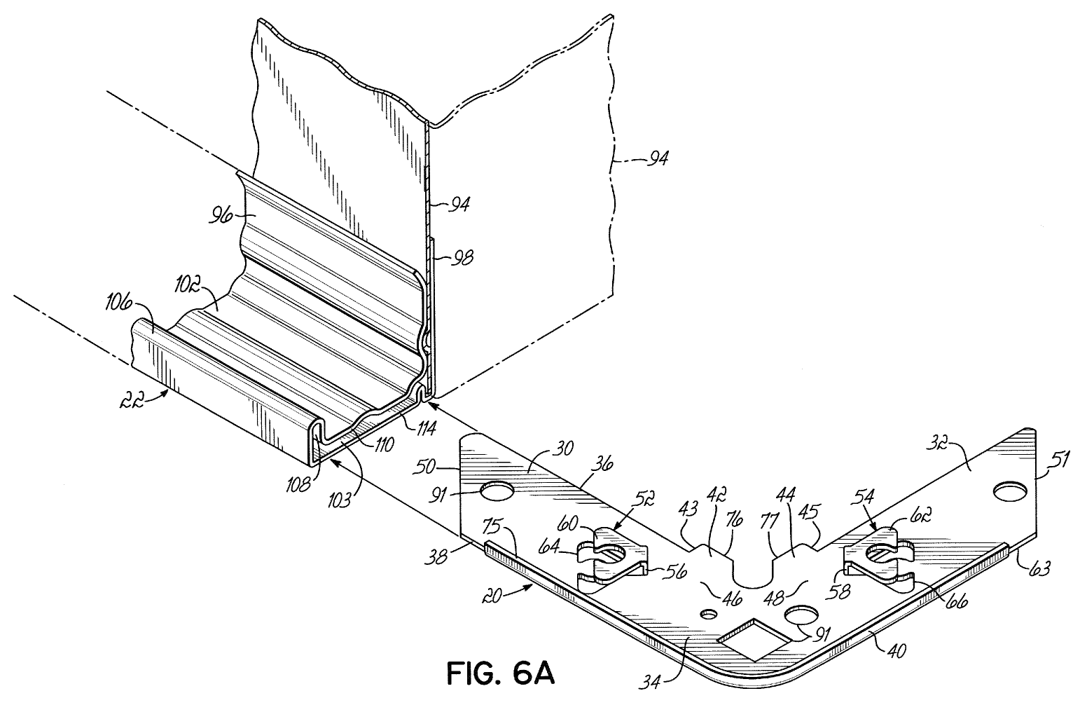

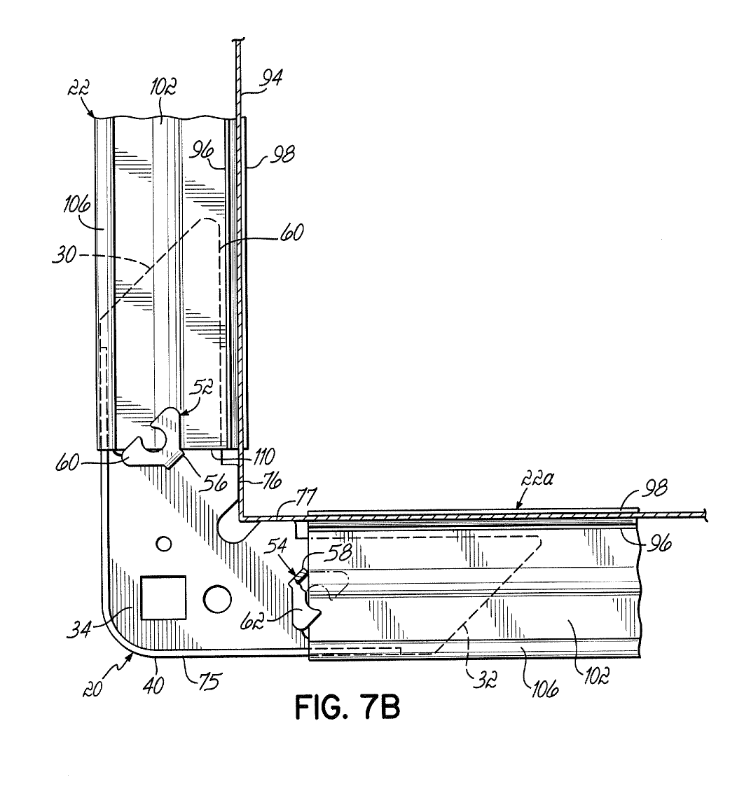

Legs 30 and 32 include protrusions which in this embodiment are punched through tabs 52 and 54. These punched through tabs include a neck members 56 and 58 and wing-shaped planar portions 60 and 62 which lie parallel to the planar surface of corner 20. Although the particular shape of the planar portions 60 and 62 can be varied, the wing configuration assists in balancing stacked corners. The tabs 52 and 54 extend from the legs 30 and 32 in the same direction as flange 40 and to a height slightly greater than that of flange 40 (see FIG. 5). As shown in FIG. 8, the reverse side 63 is planar and parallel to wing-shaped planar portions 60 and 62. Side 63 includes corresponding stamped out openings 64 and 66 from the tabs 52 and 54. The wing shaped planar portions 60 and 62 do not align with the stamped out openings 64 and 66 so that when the corners are stacked on each other as shown in FIGS. 3 and 4, the wing shaped portions 60 and 62 do not fit into stamped out openings 64 and 66. This prevents nesting.

The winged portions cross the balance line 93 of the corner. This is a theoretical line on which the corners would be balanced. This provides separation of stacked corners which allows the corners to slide relative to each other.

The corners 20 of the present invention can be utilized with integral flanges as shown in FIG. 1, 2 and 3, or non-integral flanges as shown in FIGS. 6A, 6B, 7A and 7B.

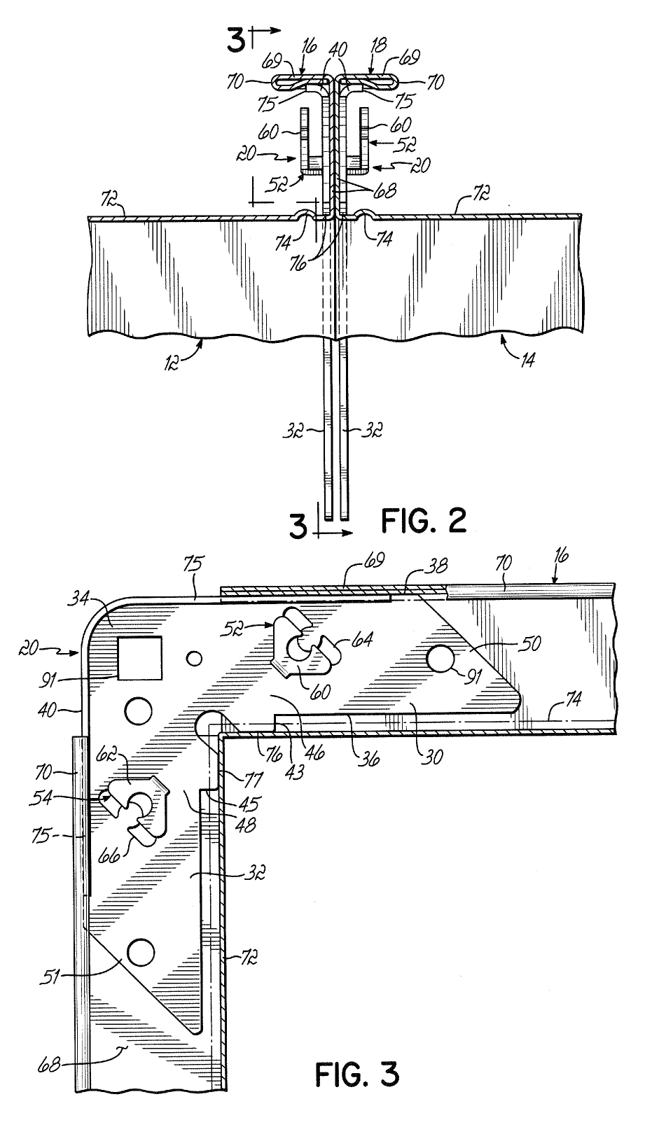

Integral flanges 16 and 18 are formed as part of the walls of the duct section. As shown more particularly in FIGS. 2 and 3, the flanges 16 and 18 have a general L-shaped configuration. It includes a first wall 68 that extends at a 90° angle from the duct wall 72. A leg portion 69 extends from the wall portion 68 and includes a lip 70. There is also a peripheral ridge 74 on duct wall 72 opposite lip 70.

As shown in FIGS. 2 and 3, the corner 20 snap fits within the flanges 16, 18 with the upper edge 75 of flange 40 engaging the lips 70 of flanges 16, 18. Likewise, the interior edge portions 76 and 77 of the larger cross sectional area 46 and 48 of legs 30 and 32 engage the duct wall between the flange wall 68 and ridge 74. This temporarily holds the corner 20 in position until two adjoining sections of duct are joined together by connecting aligned corners together with screws, bolts or other connectors. Although not shown, edge portions 76 and 77 can be bent to form slight flanges for use with TDC flanges.

As shown in FIG. 5, the corners 20 can be installed into the corner portions 80 of flanges 16 using an automatic applicator 84 diagrammatically shown in FIG. 5. This is a representative view of a typical applicator. Any automatic applicator used to install such corners can be used in the present invention.

The applicator 84 includes a stack of corners 86 which are held in a guide or magazine 87. The applicator 84 further includes a bottom support 88. The magazine 87 is spaced from the support 88 providing a gap 89, equal to the thickness of a corner 20, between the magazine 87 and the support 88. A pusher 90 slides between the support 88 and the magazine 87. The bottom most corner 20a rests on the support 88 beneath the magazine 87. The pusher 90 in turn forces the corner 20a forward in the direction of arrow 92 until it slides into an appropriate position on the section. A separate plunger (not shown) presses the corner into the appropriate position, as shown in FIG. 3.

As can be seen in FIG. 5, the wing-shaped planar members 60 and 62 (only one shown) support the corners 20 in a stack in a manner in which they do not nest. Thus, corners 20 can slide relative to each other without engaging each other or interfering with the applicator 84. This is facilitated by location of the wing shaped planar members 60 and 62 along a line of balance 93 of corner 20, diagrammatically shown in FIGS. 4 and 5. Thus, the individual corners can be stacked on each other balanced one on the other via the wing-shaped tabs.

As shown in FIG. 1, one corner 20 is positioned at each corner of each duct section 16 and 18. Once installed, the adjacent sections of duct 16 and 18 can be bolted or clipped together using any of the punched openings through the corner 20.

As shown in FIGS. 6A, 6B, 7A and 7B, the corner 20 of the present invention is also suitable for use with non-integral flanges 22. The non-integral flanges attach to an end 94 of a section of duct work. The flanges 22 are formed by bending a single strip of metal into a generally L-shaped configuration. The flange has two walls 96 and 98 which are parallel to each other and biased toward each other. Extending at a 90° angle from walls 96 and 98 are lateral sections 102 and 104 which join together at a raised portion 106 providing space 108 along the length of the flange. Also, between sections 102 and 104 is a gap 103 running along the length of the flange 22.

Corners 20 are attached to the flanges by sliding the legs 30 and 32 into adjoining flanges to hold two adjoining flanges together at a 90° angle. As shown, the leg 30 slides into the gap 103 with the flange 40 of corner 20 positioned in the space 108. The corner 20 continues to slide into gap 103 and space 108 until neck 56 engages the edge 1 10 of lateral wall 102. A second flange 22a is then slid onto leg 32 in the same manner as previously described. This is repeated with three additional corners until a continuous rectangle of non-integral flange is formed. The rectangle is then attached to the end of a duct work by sliding the end 94 of the duct work between wall sections 96 and 98. The two wall sections 96 and 98 are biased toward each other, holding the flange 22 to the duct section. Adjacent sections of the duct can then be bolted together in the same manner as with the integral flanges.

Thus, as shown, the corner of the present invention can be used with both integral and non-integral flanges of duct. Further, the corners of the present invention can be used with an automatic applicator because when stacked together the corners do not nest. This makes the corner of the present invention acceptable for almost all major integral and non-integral flanges.

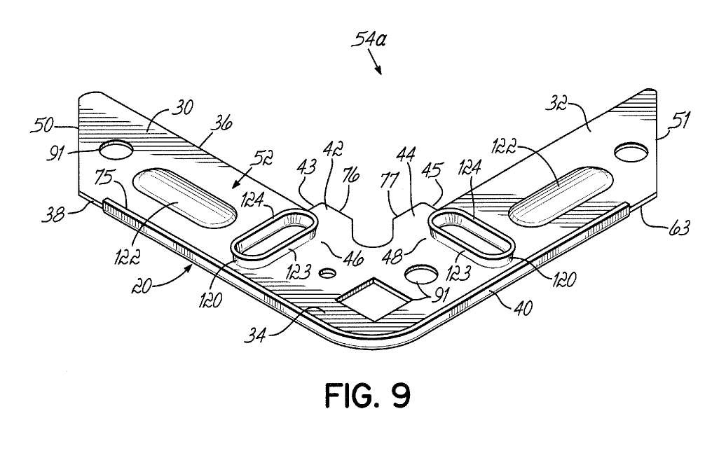

An alternate embodiment of the present invention is shown in FIG. 9. In this embodiment, the corner 54a has protrusions 120 which are extruded holes through the legs 30 and 32 of corner 54a. The extruded holes 120 have a wall 123 that terminates in a flared rim 124. The flared rim prevents nesting of stacked corners. These corners also have a debossment 122 which provides structural rigidity.

The protrusions 120 extend through the balance line of the corner 54a providing for support of the corner by only the two protrusions 120.

This illustrates that a variety of different protrusions can be employed. For example, simply a single walled tab which is slightly flared or bent outward to prevent nesting will also provide adequate support for the flanges of the present invention.

Preferably, these protrusions have a length perpendicular to the respective legs that provides significant support. Generally, these will be at least ¼ inch in length, and preferably ½ inch to ¾ inch, or more. This provides stability for a stack of corners.

This has been a description of the present invention along with the preferred method of practicing the present invention. However, the invention itself should only be defined by the appended claims, wherein

I claim:

1. An L-shaped corner for connecting sections of duct, said corner: comprising first and second legs joined at a corner portion;
an outer edge;
an inner edge;
said inner edge of said first and second legs having first and second outwardly stepped portions;
said legs having first and second tabs bent outwardly in a first direction, said tabs having a neck portion extended outwardly from said legs, a planar portion extended from said neck portion and parallel to said legs, said planar portion preventing stacked corners from nesting.

2. The L-shaped corner claimed in claim 1 wherein said outer edge having a flange extended in said first direction for a distance less than or equal to a height of said tabs.

3. The L-shaped corner claimed in claim 1 wherein said inner edge extends from distal ends of said legs to proximal ends of said legs and having first and second stepped portions between said distal and proximal ends of said legs.

4. The L-shaped corner claimed in claim 1 wherein said tabs are located on a balance line of said corner.

5. A non-nesting corner adapted to attach to a flange of duct comprising first and second planar legs;
an outer edge having a flange extended in a first direction from said planar legs;
first and second protrusions extended in said first direction from said legs, said protrusions lying on a balance line of said corner preventing stacked corners from nesting.

6. The corner claimed in claim 5 wherein said protrusion is a tab having a planar portion.

7. The corner claimed in claim 5 wherein said protrusion is a flared wall.

8. The corner claimed in claim 7 wherein said wall surrounds a hole.

9. The corner claimed in claim 6 wherein said corner has an inner edge said inner edge having first and second stepped portions one each on said first and second legs.

10. The corner claimed in claim 6 wherein said planar portions have a general wing-shaped configuration and said tabs each having a neck portion extending from said leg upwardly to said wing portions.

11. A stack of corners said corners adapted to attach to a flange of duct;
each corner comprising first and second legs connected at about 90 degrees;
each corner having a line of balance transecting said legs;
each leg of each corner having a protrusion intersecting said line of balance;
said protrusions supporting said corners in said stack.

12. The stack of corners claimed in claim 11 wherein said protrusions comprise tabs.

13. The stack of corners claimed in claim 11 wherein said protrusions are flared walls surrounding a hole.
